(19) United States
(12) Patent Application Publication
(10) Pub. No.: US 2005/0223126 A1
(43) Pub. Date: Oct. 6, 2005

(54) Buffer controller between memories and method for the same

(76) Inventors: Li Wei Chu, Hsinchu (TW); Chen Min Chiang, Hsinchu (TW); Chih-Chen Tsai, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/813,047

(22) Filed: Mar. 31, 2004

(51) Int. Cl. G06F 13/28

(52) U.S. Cl. 710/22; 711/165

(57) ABSTRACT

A buffer controller between a first and a second memories is used to control the buffer during data transmission process for memories. The buffer controller between memories has a microprocessor used to process the data transmission of the memory bus, a first memory connected to the microprocessor, and a second memory also connected to the microprocessor. The first memory and the second memory therefore transmit data under the control of the microprocessor.

### FIELD OF THE INVENTION

The present invention relates to a buffer controller between memories and a method for the same, and especially to a buffer controller used to control the data transmission between memories and a method for the same.

### BACKGROUND OF THE INVENTION

The conventional programmable Input/Output transmission module uses a processor to connect and control data transmission channels between two devices. The processor uses a data bus, an address bus and a control bus to connect the I/O ports of two external memories.

The processor transmits a control signal to the I/O ports of the two external memories through the control bus, transmits an address signal to the I/O ports of the two external memories through the address bus and transmits data through the data bus in parallel.

Nevertheless, there are diverse types of memory devices with different control parameters. The firmware of the programmable Input/Output transmission module has a complicated design and the performance thereof is influenced. Moreover, the programmable Input/Output transmission module is hard to adapt for external memories with expanding address and capacity.

### SUMMARY OF THE INVENTION

It is an object to provide a buffer control architecture between memories and method thereof, which changes states of a plurality of registers in a microprocessor to control the transmission between external memory devices, and also control the state inspection of the memory devices. The present invention also can change the states of the registers in the microprocessor to make the access of the memory devices more flexible.

### BRIEF DESCRIPTION OF DRAWINGS

The various objects and advantages of the present invention will be more readily understood from the following detailed description when read in conjunction with the appended drawing, in which:

FIG. 1 shows a block diagram of the preferred embodiment of a buffer control architecture and method between memories according to the present invention; and

FIG. 2 shows a flowchart of the preferred embodiment of a buffer control architecture and method between memories according to the present invention.

### DETAILED DESCRIPTION OF THE INVENTION

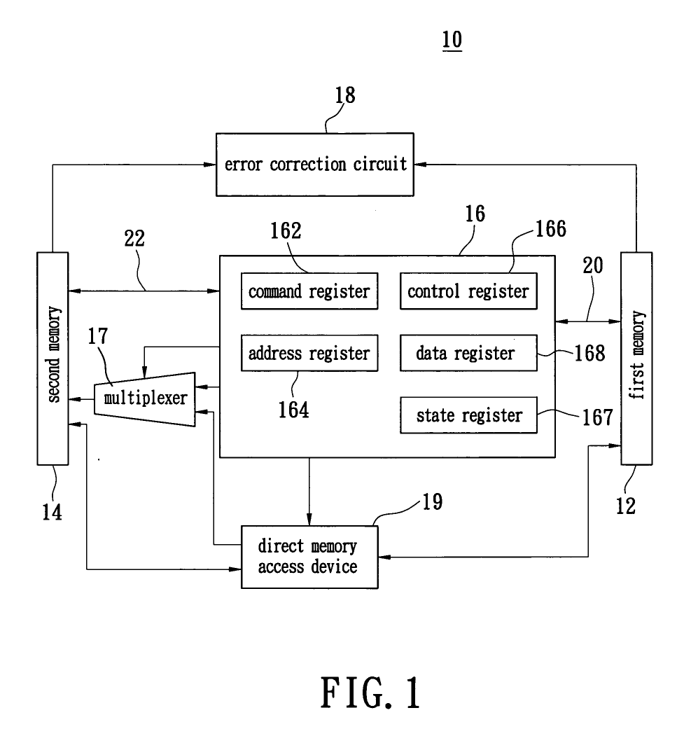

FIG. 1 shows a block diagram of the preferred embodiment of a buffer control architecture and method between memories according to the present invention. The buffer controller 10 between a first memory 12 and a second memory 14 comprises a microprocessor 16, a multiplexer 17, an error correction circuit 18 and a direct memory access device 19.

The microprocessor 16 comprises a command register 162 used to transmit a write command of the microprocessor 16 to the first memory 12, and an address register 164 used to transmit an address data to the first memory 12.

The address register 164 is composed of two address latches; one is an ALEH (address latch enable high) latch and another is an ALEL (address latch enable low) latch.

When the ALEH latch is at a logic high level, the address signal transmitted by the microprocessor 16 is in an enable state. When the ALEL latch is at a logic high level, the address signal transmitted by the microprocessor 16 is in a disable state.

The microprocessor 16 further comprises a control register 166 used to control the enable state and width of write/read pulse duration of the first memory 12, a data register 168 used to control the length of the transmission data and a state register 167 used to read the state of the first memory 12.

The first preferred embodiment of the present invention is disclosed below. When the second memory 14 transmits data to the first memory 12, the second memory 14 will at first transfer the data to the data register 168 in the microprocessor 16 through the second data bus 22. The control register 166 in the microprocessor 16 enables the first memory 12, and the command register 162 controls the state of data to a “write” state and the input of the address signal is controlled by the address register 164. The address register 164 is composed of two registers; one is an ALEH (address latch enable high) latch and another is an ALEL (address latch enable low) latch. When the ALEH is at a logic high level, the address signal transmitted by the microprocessor 16 is in an enable state, and the microprocessor 16 transmits the address data to the first memory 12. When the ALEL is at a logic high level, the address signal transmitted by the microprocessor 16 is in a disable state, and the microprocessor 16 continues transmitting the address data to the first memory 12. When the transmission of the address data is completed, the ALEL is set to a logic low level, and the ALE (address latch enable) goes to a logic low level. Therefore, the microprocessor 16 will stop transmitting the address data to the first memory 12.

When the ALE of the microprocessor 16 is at a high level, the control register 166 will adjust the pulse width of the write signal. The transmission speed of the microprocessor 16 can therefore match first memory 12 of different types.

The microprocessor 16 sets the transmission data type to two kinds of type by the data register 168. The two types of data include 8-byte data and 16-byte data. The microprocessor 16 detects the data type of the first memory 12 through the state register 167, and the microprocessor 16 chooses the corresponding data type in the data register 168 to match that of the first memory 12. The data register 168 will therefore control the transmission data to the first memory 12 through a first bus 20.

The first memory 12 has a plurality of states such as ready/busy (R/B) state, write protection (WP) state and data transmission state. The type of the data transmission state can be separate into 8-byte and 16-byte states. The microprocessor 16 can detect the state of the first memory 12 by the state register 167.

With refer to FIG. 1, to complete data transfer from the first memory 12 to the second memory 14, the microprocessor 16 firstly enables the first memory 12 through the control register 166. Afterward, the command register 162 controls the data flow to a read direction and the address register 164 controls the input of the address signal. The data register 168 sets the data type of the transmission data according to data in the first memory 12 detected by the state register 167. The data types of the transmission data are separated into 8-byte data and 16-byte data.

After the data is registered in the data register 168, the microprocessor 16 sends an address signal and a write command to the second memory 14. The data is then transmitted to the second memory 14 through the second bus 22.

With reference also to FIG. 1, during the data transaction between the first memory 12 and the second memory 14, the microprocessor 16 controls the error correction circuit 18 to detect and correct the transmission data. The transmitted data will therefore be more accurate. When the first memory 12 and the second memory 14 are transmitting data, the microprocessor 16 decides whether the DMA DEVICE 19 will participate in the control of data transmission. If the transmission data is very large, the microprocessor will assign the transmission jobs to the direct memory access (DMA) device 19. Therefore, the DMA device 19 controls the data transmission between memories.

FIG. 1 also shows the multiplexer 17 is under the control of the microprocessor 16 to choose the source of the address signal and command signal of the second memory 14. When the DMA device 19 takes control of the data transmission, the multiplexer 17 outputs the address signal and command signal of the DMA device 19, or the address signal and command signal will be the output signal of the microprocessor 16.

FIG. 1 also shows that the first memory 12 is a flash memory, the second memory 14 is a static random access memory (SRAM), and the microprocessor 16 is an 8051 chip.

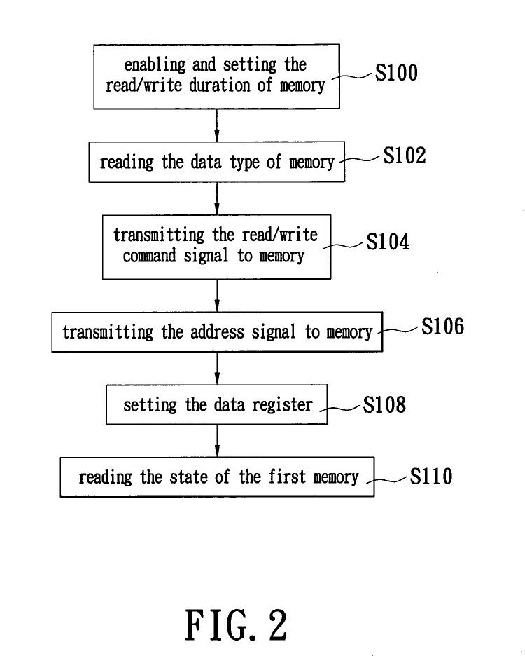

FIG. 2 shows the flowchart according to the preferred embodiment of the present invention as follows: (step s100) enabling and setting the read/write duration of the first memory by setting the control register; (step s102) reading the data type of the first memory (namely, either 8 bit or 16 bit) to set the state register; (step s104) transmitting the read/write command signal to the first memory by setting the command register; (step s106) transmitting the address signal to the first memory by setting the address register, which can be an ALEH or an ALEL; (step s108) setting the data register to read or write the 8-byte or the 16-byte data to the first memory; and (step 110) reading the state of the first memory and storing the state of the first memory in the state register.

With additional reference to FIG. 1, the flowchart in FIG. 2 shows that the microprocessor 16 sets the internal control register 166 to enable the first memory 12 and adjusts the pulse duration of the read signal to match the speed of the first memory 12, and then reads the data type of the first memory 12 to set the state register 167.

Afterward, the microprocessor 16 sets the command register 162 to transmit the command data to the first memory 12, and transmits the address signal to the first memory 12 by setting the address register 164, then the microprocessor 16 reads/writes the first memory 12 by setting the data register 168. Finally, the microprocessor 16 reads the state of the first memory 12 and stores that in the state register 167.

As mentioned above, the present invention uses the register of the microprocessor 16 to control the transmission between memories and to be the transmission interface of the memories. The control register 166 adjusts the read/write duration of the microprocessor 16. Therefore, the present invention can be applied at different speeds between different memories.

The address register 164 controls the address signal of the address register 164 in the microprocessor 16, so the microprocessor 16 can address memories of different sizes and different types.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the scope of the invention as defined in the appended claims.

1. A buffer controller between memories, comprising:
a microprocessor used to process data transmission for the memories;
a first memory connected to the microprocessor; and
a second memory connected to the microprocessor;
wherein the first memory and the second memory transmit data to each other through the microprocessor.

2. The buffer control architecture between memories as in claim 1, further comprising a direct memory access (DMA) connecting among the microprocessor, the first memory and the second memory.

3. The buffer control architecture between memories as in claim 1, further comprising an error correction circuit connecting to the microprocessor, the first memory and the second memory.

4. The buffer control architecture between memories as in claim 1, further comprising a multiplexer connecting to the microprocessor, the first memory and the second memory.

5. The buffer control architecture between memories as in claim 1, wherein the first memory is a flash memory.

6. The buffer control architecture between memories as in claim 1, wherein
the second memory is a static random access memory (SRAM).

7. The buffer control architecture between memories as in claim 1, wherein
the microprocessor is an 8051 chip.

8. The buffer control architecture between memories as in claim 1, wherein the microprocessor further comprises:
a command register used to transmit a write command to the first memory;
an address register used to control a transmission of the address data to the first memory;
a control register used to enable the first memory and control a read/write pulse duration of the first memory;
a data register used to control a data type of the transmission data; and
a data register used to read a state of the first memory.

9. A buffer controlling method between memories comprising steps as follows:
setting a value for a control register to control an enable operation of a memory;
setting a value for a state register to read a data type of the memory; setting a value for a command register to transmit a command data to the memory;
setting a value for an address register to transmit an address signal to the memory;
setting a value for a data register to access the memory; and
setting a value for a state register to read a state of the memory.

10. The buffer control method between memories as in claim 9, further comprising setting the value for the control register to adjust a pulse duration of the read/write signal.

11. The buffer control method between memories as in claim 9, wherein the address register is an ALEH latch or an ALEL latch.

12. The buffer control method between memories as in claim 9, wherein the value for the data register is selected to determine a transmission data type, and the transmission data type is 8-byte data or 16-byte data.
